(19) United States
(12) Patent Application Publication
(10) Pub. No.: US 2019/0057170 A1
(43) Pub. Date: Feb. 21, 2019

(54) Identifying and Removing Sets of Sensor Data from Models

(71) Applicant: Arundo Analytics, Inc., Palo Alto, CA (US)

(72) Inventors: Matthew Strecker Burriesci, Half Moon Bay, CA (US); Martin Jared Lee, Sunnyvale, CA (US); Mogens L. Mathiesen, Oslo (NO)

(73) Assignee: Arundo Analytics, Inc., Palo Alto, CA (US)

(21) Appl. No.: 15/677,836

(22) Filed: Aug. 15, 2017

(51) Int. Cl. G06F 17/50

(52) U.S. Cl. CPC G06F 17/5009; G06F 2217/02

(57) ABSTRACT

A system and method including receiving a request to remove a contribution of a targeted sensor data set from a construction of a model. The targeted sensor data set is from a plurality of sensor data sets, each of the plurality of sensor data sets is associated with sensors monitoring industrial systems, the model is constructed at least in part from the plurality of sensor data sets, and each of the plurality of sensor data sets is tagged with at least one unique accession identifier. An accession identifier associated with the targeted sensor data set is then identified, and the construction of the model is modified to remove the contribution of the targeted sensor data set based at least in part on identifying the accession identifier associated with the targeted sensor data set.

### A. BACKGROUND

The invention relates generally to identifying and/or removing sets of sensor data from models constructed at least partially using the sets of sensor data.

Industries such as manufacturing, oil, natural gas, chemical, mining, and the like use predictive models in connection with maintaining the industrial systems employed in such industries. These models can be used to predict failures of and prevent problems, for example, associated with the operation of the equipment and subsystems that make up the industrial systems. Generally, such models may also be used to increase the overall efficiency of these industrial systems.

The accuracy of the models increases with the amount of data used to train the models. For that purpose, system owners may be willing to contribute data to build models that can then be shared among the owners. Thus, models can be built using data received from multiple sources that may be owned by different parties. If a data owner withdraws permission to use its data in connection with a model, the contributions of such data cannot easily be removed from the model. Consequently, that particular data must be removed from the set of data originally used to build the model, and the model must be rebuilt from scratch using the reduced data set. This can be a time consuming and costly process.

### B. SUMMARY

In one respect, disclosed is a computer-implemented method including receiving a request to remove a contribution of a targeted sensor data set from a construction of a model. The targeted sensor data set is from a plurality of sensor data sets, each of the plurality of sensor data sets is associated with sensors monitoring industrial systems, the model is constructed at least in part from the plurality of sensor data sets, and each of the plurality of sensor data sets is tagged with at least one unique accession identifier. An accession identifier associated with the targeted sensor data set is then identified, and the construction of the model is modified to remove the contribution of the targeted sensor data set based at least in part on identifying the accession identifier associated with the targeted sensor data set.

In another respect, disclosed is a system that includes one or more processing units and one or more memory units coupled to the one or more processing units. The one or more memory units are configured to store instructions, and the one or more processing units are configured to execute the instructions causing the system to perform operations including receiving a request to remove a contribution of a targeted sensor data set from a construction of a model. The targeted sensor data set is from a plurality of sensor data sets, each of the plurality of sensor data sets is associated with sensors monitoring industrial systems, the model is constructed at least in part from the plurality of sensor data sets, and each of the plurality of sensor data sets is tagged with at least one unique accession identifier. An accession identifier associated with the targeted sensor data set is then identified, and the construction of the model is modified to remove the contribution of the targeted sensor data set based at least in part on identifying the accession identifier associated with the targeted sensor data set.

In yet another respect, disclosed is at least one non-transitory, machine-accessible storage medium having instructions stored thereon. The instructions are configured, when executed on a machine, to cause the machine to perform operations including receiving a request to remove a contribution of a targeted sensor data set from a construction of a model. The targeted sensor data set is from a plurality of sensor data sets, each of the plurality of sensor data sets is associated with sensors monitoring industrial systems, the model is constructed at least in part from the plurality of sensor data sets, and each of the plurality of sensor data sets is tagged with at least one unique accession identifier. An accession identifier associated with the targeted sensor data set is then identified, and the construction of the model is modified to remove the contribution of the targeted sensor data set based at least in part on identifying the accession identifier associated with the targeted sensor data set.

Numerous additional embodiments are also possible.

### C. BRIEF DESCRIPTION OF THE DRAWINGS

Other objects and advantages of the invention may become apparent upon reading the detailed description and upon reference to the accompanying drawings.

FIG. 1 is a block diagram illustrating a system for utilizing accession identifiers to label sets of sensor data, in accordance with some embodiments.

FIG. 2 is a block diagram illustrating another system for utilizing accession identifiers to label sets of sensor data, in accordance with some embodiments.

FIG. 3 is a block diagram illustrating yet another system for utilizing accession identifiers to label sets of sensor data, in accordance with some embodiments.

FIG. 4 is a flow diagram illustrating a method for utilizing accession identifiers to label sets of sensor data, in accordance with some embodiments.

FIG. 5 is a flow diagram illustrating another method for utilizing accession identifiers to label sets of sensor data, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

Disclosed below are various concepts related to, and embodiments of, systems and methods for using accession identifiers to label sensor data sets associated with industrial systems as well as predictive models for the industrial systems built using the sensor data sets.

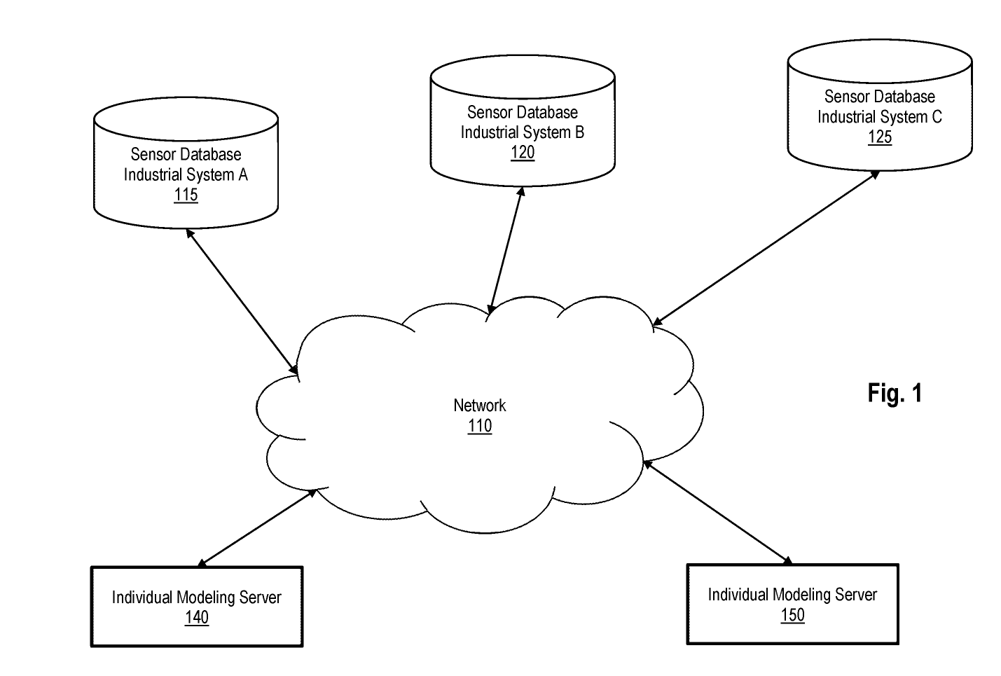

FIG. 1 is a block diagram illustrating a system for utilizing accession identifiers to label sets of sensor data, in accordance with some embodiments.

The sensor data sets may be associated with sensors monitoring one or more industrial systems utilized in industries such as manufacturing, oil, natural gas, chemical, and mining. For example, in the oil industry, the industrial systems may be oil rigs. More generally, the sensor data sets may include any data associated with the operation of the industrial systems. In the illustrated embodiment, three industrial systems are shown, Industrial System A, Industrial System B, and Industrial System C, but the systems and methods disclosed herein may be applied to any number of industrial systems.

Sensor data sets for Industrial Systems A, B, and C may be obtained from sensor database 115 associated with Industrial System A, sensor database 120 associated with System B, and sensor database 125 associated with System C. The sensor data contained in the sensor databases may include both sensor readings data and sensor metadata. Sensor reading data includes output from the sensors monitoring the associated industrial system. This may include various readings, signals, or other data received from the sensors such as temperature, pressure, liquid flow rate, resistance, voltage, current, etc. Sensor metadata generally includes information about the sensors. This may include various text labels and keywords such as sensor names, manufacturer, model numbers, product descriptions, or any other information that describe the sensors. Sensor metadata may also include information that helps manage the sensors, such as installation or service dates, hierarchical information, error messages, or operational log entries.

Sensor databases 115, 120, and 125 may include historical or real-time data obtained from databases containing production or condition data from industrial or production systems and utilize operational historian database software applications to manage the data. Operational historians may generally be used to record trends and historical process data for the systems for future reference. The operational historians may be configured to capture sensor readings data, as well as other system information about production status, performance monitoring, quality assurance, tracking and genealogy, and product delivery with enhanced data capture, data compression, and data presentation capabilities.

Sensor data may be obtained through querying using SQL or another suitable database querying language or through an API that pulls data, such as timepoints or ranges of timepoints. It can be returned in ASCII or another suitable human-readable format or encoded in a defined machine-readable format. The sensor data sets are made available in the system memory (such as RAM) of the sensor database to be transmitted over a network for further processing. In the system memory, non-human readable, compressed, or even encrypted entries can be inflated and/or decrypted for further use.

The sensor data sets are assigned accession identifiers that identify the sensor data sets as more fully described below. In some embodiments, the accession identifiers uniquely identify the sensor data sets. The accession identifiers may be assigned to the sensor data sets at any time prior to the point where sensor data sets are combined with other data sets or are commingled in models built using the data sets. In some embodiments, the accession identifiers may be added at the time that the sensor data sets are pulled from the sensor databases. In some embodiments, the accession identifiers may be assigned after the sensor data sets have undergone preliminary cleaning, such as the removal of blank or obviously erroneous data from the sensor data sets. Such cleaning instructions/steps may be recorded in a data ledger.

Returning to FIG. 1, network 110 may be used to transmit sensor data sets from sensor readings databases 115, 120 and 125 to individual modeling server 140. Network 110 can be any suitable type of network allowing transport of data communications across it. For example, network 110 may be a local area network (LAN), wide area network (WAN), the internet, a SCADA network, a wireless network or any other communication network, or any combination thereof. In some embodiments, the sensor readings and metadata databases and the individual modeling server may be located at the same site or even on the same physical machine, in which case the information can be shared between programs in system memory without need for a network. The sensor data can be compressed and/or encrypted for transmission to the individual modeling server. While one individual modeling server is shown, multiple individual modeling servers may be used in some embodiments.

Individual modeling server 140 uses one or more of the sensor data sets received from Industrial Systems A, B, and C to generate models for predicting outcomes associated with the operation and functioning of the industrial systems, for example, which can be used to identify potential failures and take preventive or remedial action with respect to the industrial systems. For example, a particular model may use data sets containing sensor data associated with the operation of a particular component of an industrial system to categorize the likelihood of the particular component as likely to fail or require maintenance within a particular time range. The predictive models may be generated using techniques such as soft margin support vector machines (SVMs), tree-based techniques, random forests, boosting, logistic regression, artificial neural networks, and other supervised or unsupervised learning algorithms. Further description and details of these learning techniques are described in U.S. Patent Application Publication No. 2006/0150169, entitled “OBJECT MODEL TREE DIAGRAM,” U.S. Patent Application Publication No. 2009/0276385, entitled “ARTIFICIAL-NEURAL-NETWORKS TRAINING ARTIFICIAL-NEURAL-NETWORKS,” U.S. Pat. No. 8,160,975, entitled “GRANULAR SUPPORT VECTOR MACHINE WITH RANDOM GRANULARITY,” and U.S. Pat. No. 5,608,819, entitled “IMAGE PROCESSING SYSTEM UTILIZING NEURAL NETWORK FOR DISCRIMINATION BETWEEN TEXT DATA AND OTHER IMAGE DATA,” which are herein incorporated by reference in their entirety.

Each model built by an individual modeling server may be labeled an accession identifier. In some embodiments, a model may be tagged with all of the accession identifiers associated with the sensor data sets used to build the model. This permits the contribution of each sensor data set to be readily identified in the models built using the data set.

In some embodiments, the models generated by individual modeling server 140 may be transmitted via network 110 to ensemble modeling server 150. Ensemble modeling server 150 may be used to generate ensemble models by combining sets of the individual models obtained from individual modeling server 140 to form combined supermodels known as ensemble models. In some embodiments, individual modeling server 140 may be configured to generate ensemble models using the individual models. The individual models are weighted within the ensemble models using one or more factors such as the amount of data in each individual model, the quality of the data used in each individual model, the similarity of the underlying equipment or subsystem used in the individual model to the equipment or subsystem the ensemble machine is supposed to predict, or the accuracy of any individual model on data from the equipment or subsystem that the ensemble model is supposed to predict. Ensemble models obtain better predictive performance than could be obtained from any single model generated by individual modeling server 140. Further description and details of ensemble modeling are described in U.S. patent application Ser. No. 15/134,905, filed on 21 Apr. 2016, entitled “SYSTEMS AND METHODS FOR FAILURE PREDICTION IN INDUSTRIAL ENVIRONMENTS.” The above referenced patent application is included here by reference in its entirety.

Each ensemble model may be tagged with the accession identifiers of every individual model used to produce it. In this manner, the contribution of each sensor data set may be readily identified in the ensemble models built using the data set.

Although FIG. 1 shows single sensor databases for Industrial Systems A, B, and C and a single individual modeling server and ensemble modeling server, multiple databases may be used to store the sensor data sets for Industrial Systems A, B and C, and multiple individual modeling servers may be used to generate the individual models and multiple ensemble modeling servers may be used to generate the ensemble models.

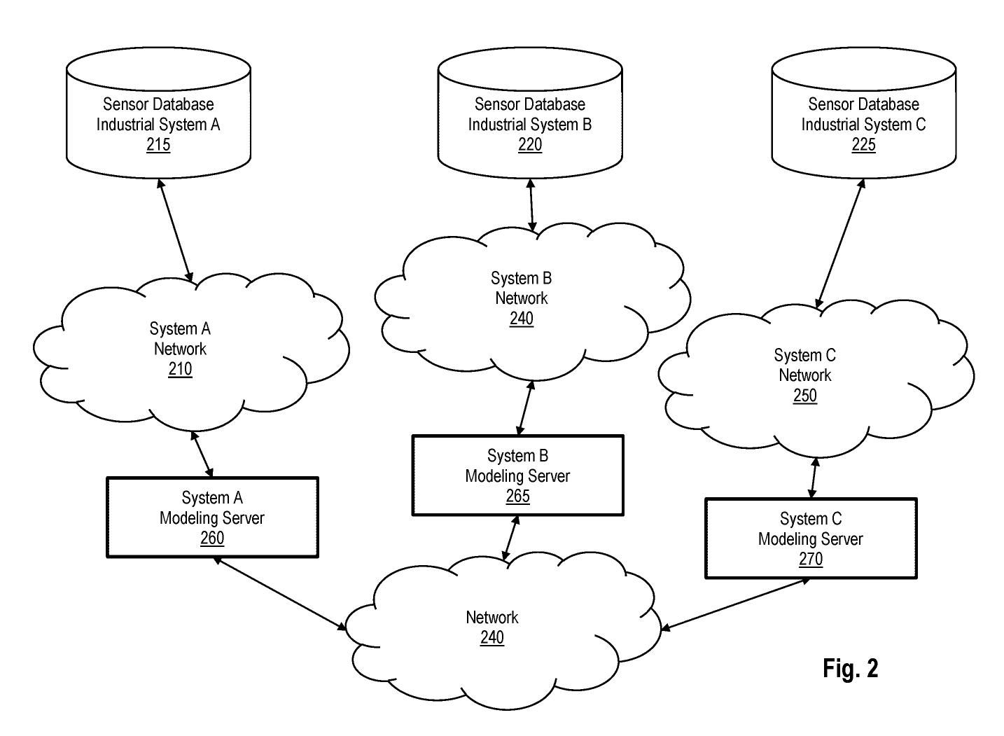

FIG. 2 is a block diagram illustrating another system for utilizing accession identifiers to label sets of sensor data, in accordance with some embodiments.

An industrial system is represented in FIG. 2 that includes three industrial systems, Industrial System A, Industrial System B, and Industrial System C, but the systems and methods disclosed herein may be applied to any number of industrial systems.

Sensor data sets for Systems A, B, and C may be obtained from sensor databases 215, 220, and 225, respectively. Sensor database 215 may include output from the sensors monitoring Industrial System A. Sensor database 220 may include output from the sensors monitoring Industrial System B. Sensor database 225 may include output from the sensors monitoring Industrial System C. Sensor databases 215, 220, and 225 may also contain other production or condition data from the industrial systems as well as metadata related to the industrial system and sensors monitoring the operations of the industrial systems.

The network topology illustrated in FIG. 2 may be utilized where data privacy is an issue. Network 210 is used to transmit the sensor data for Industrial System A from sensor database 215 to modeling server 260. Similarly, network 240 is used to transmit sensor data for Industrial System B from sensor database 220 to modeling server 265, and network 250 is used to transmit sensor data sets for Industrial System C from sensor database 225 to modeling server 270. Networks 210, 240, and 250 can be any suitable type of network allowing the transport of data communications. However, in situations where data security is a concern, closed or secured communication networks may be utilized or suitable security measures employed to prohibit the sharing of data between the networks. This allows the raw sensor data from Industrial Systems A, B, and C to be kept completely separate during the model generation process. Additionally, communications and data stored or transmitted among the sensor databases and modeling servers can be encrypted using asymmetric cryptography, Advanced Encryption Standard (AES) with a 256-bit key size, or any other encryption standard known in the art.

Accession identifiers are assigned to sensor data sets, which identify the sensor data as belonging to the applicable industrial systems as more fully described below. The accession identifiers may be assigned to the sensor data sets at any time prior to the point where the sensor data sets are combined with other data or are commingled with other data in models built using the sensor data sets.

Modeling server 260 generates individual models for the equipment and subsystems of Industrial System A using sensor data sets constructed from the sensor data received obtained from sensor database 215. Likewise, modeling server 265 generates individual models for the equipment and subsystems of Industrial System B using sensor data sets constructed from the sensor data received obtained from sensor database 220, and modeling server 270 generates individual models for the equipment and subsystems of Industrial System C from sensor data sets constructed using the sensor data received obtained from sensor database 225. As discussed above, the models generated by the modeling servers can be used to predict and prevent problems associated the operation and functioning of the equipment and subsystems of the industrial systems, for example.

The models generated by modeling servers 260, 265, and 270 may be transmitted between the modeling servers through network 280. In some embodiments, one or more of modeling servers 260, 265, and 270 may be configured to generate ensemble models using individual models received from one or more of the modeling servers. This shared network is the first place in this network topology where there is any contact or communication between Industrial Systems A, B, and C. In some embodiments, the data in the sensor databases may contain sensitive information that the owner of one industrial system would not want to share with the owner of another industrial system. Such information might include the identity and location of a given industrial system (or even the identity of the owner of the industrial system), or it might include specific production and downtime data. Using the disclosed system, all communications of one industrial system's data to another industrial system only occurs through the form of models passed between modelling servers through network 280. In this way, data can be anonymized or summarized to prevent sensitive data from being shared between industrial systems.

In some embodiment, the models from modeling servers 260, 265, and 270 may be transmitted through network 280 to an ensemble model server 290, which combines individual models received from the modeling servers to form ensemble models.

Each model built by modeling servers 260, 265, and 275 may be labeled with an accession identifier. In some embodiments, the accession identifier of a model may include a combination of the accession identifiers associated with the sensor data sets used to build the model. Additionally, each ensemble model built using modeling servers 260, 265, and 275 or ensemble modeling server 290 may be tagged with the accession identifiers of every individual model used to produce it. In this manner, the contribution of each sensor data set may be readily identified in the models and ensemble models built using the data set.

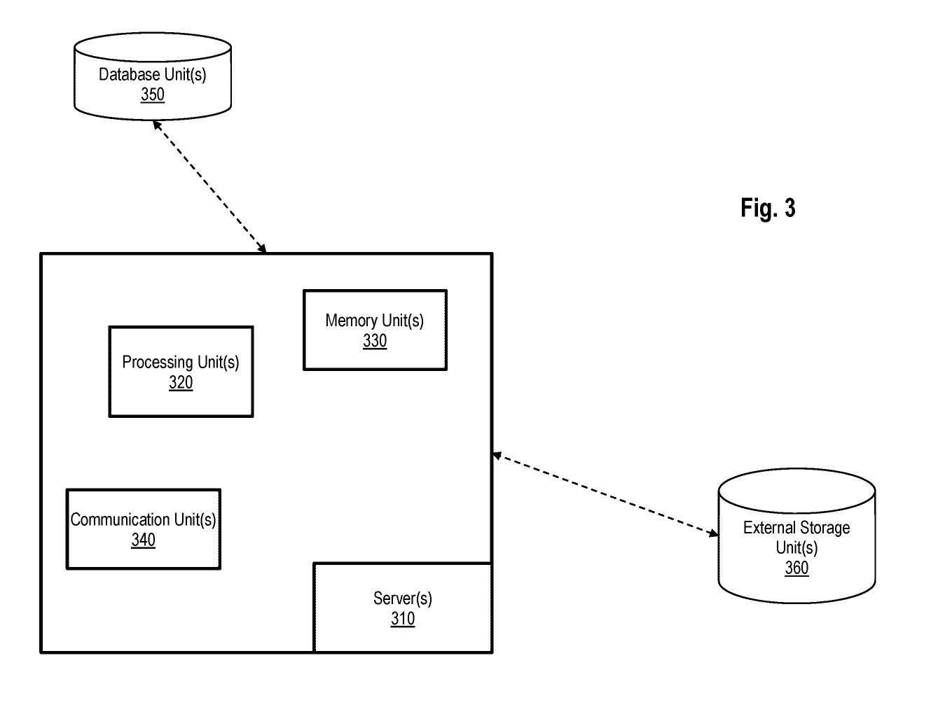

FIG. 3 is a block diagram illustrating yet another system for utilizing accession identifiers to label sets of sensor data, in accordance with some embodiments.

In some embodiments, one or more servers are configured to perform at least partially the functionality of the systems shown and described in FIG. 1 and FIG. 2.

In some embodiments, the servers 310 may comprise one or more processor units 320, which are coupled to one or more memory units 330. The processor units 320 and the memory units 330 are configured to implement, at least partially, the functionality of servers 310. Servers 310 may also comprise one or more communication units 340 that are configured to communicate with other units. Servers 310 may comprise other units as well.

Processor units 320 are configured to execute instructions in order to implement the functionality of servers 310. Processor units 320 are coupled to and are configured to exchange data with one or more memory units 330, which are configured to store instructions that are to be executed by processor units 320. In some embodiments, the instructions may also be stored in other non-transitory, machine-accessible storage media.

Servers 310 may be also configured to receive data, such as sensor data, for example, from one or more database units 350. Furthermore, servers 310 may be configured to output any results to one or more external storage units 360.

It should be noted that the functionality of all the units shown may be divided into additional units placed across communication buses, communication networks, etc.

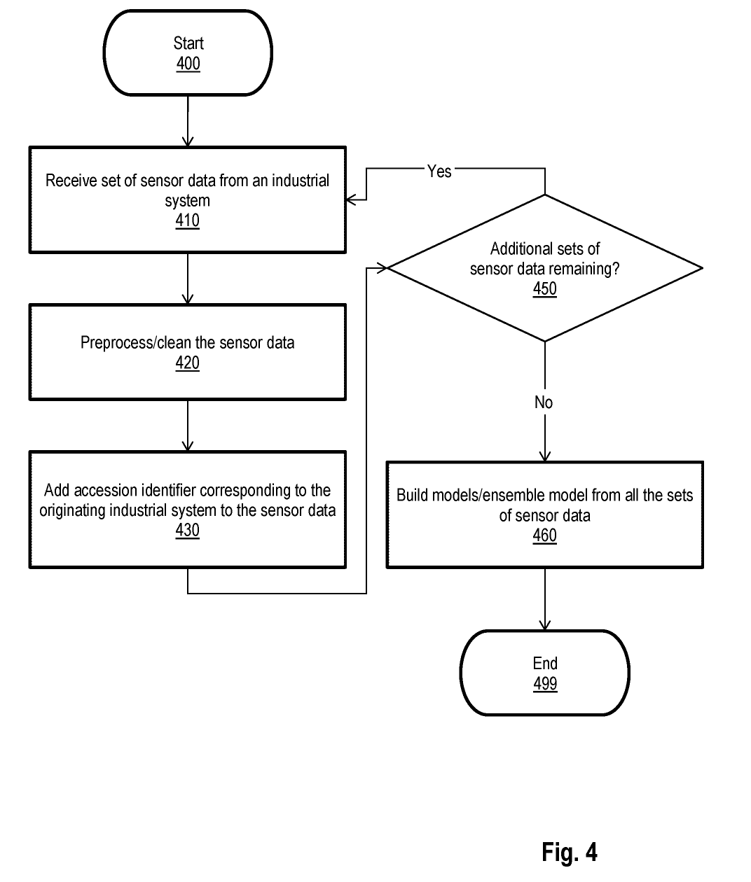

FIG. 4 is a flow diagram illustrating a method for utilizing accession identifiers to label sets of sensor data, in accordance with some embodiments.

Processing begins at 400 whereupon, at block 410, sets of sensor data are received. In some embodiments, the sensor data may be from sensors that are part of industrial systems, such as oil rigs. The term industrial systems, as used here, may include industrial systems from other industries, such as manufacturing, natural gas, mining, and chemical industries. It should also be noted that the term industrial systems may generally include any system with equipment and sensors such as a computer server farm, for example.

In some embodiments, the sensor data may be obtained from one or more databases where sensor data was stored over time from one or more industrial systems. In some embodiments, the sensor data may be obtained directly from the one or more industrial systems.

At block 420, the sensor data may be preprocessed and/or cleaned before further processing. For example, blank or obviously erroneous signals may be removed. Errors may include out-of-bound values, nonsensical values (like negative values on a temperature sensor set to record in kelvin), and/or values with little predictive value (for example, multiple redundant values of a functioning state may be reduced to a few values). Additionally, certain bad collection periods may be removed from certain sensors. For example, during a certain period, a certain sensor may have been known to have output incorrect but not out-of-bound values due to a known fault. Furthermore, sensor data may be removed when the data includes engineering features that are combinations of sensors. Such combinations may include, for example, the pressure and volume of a gas in cases where those values' product (P*V) may more likely to be predictive of a temperature value.

At block 430, different accession identifiers are added to the different sensor data sets. In some embodiments, the accession identifiers will remain tagged/associated with their corresponding sensor data set(s) as the sensor data sets are processed with other sensor data sets to yield models and ensemble models, for example.

In some embodiments, a specific accession identifier may be assigned to a sensor data set that is received from a specific industrial system, such as a specific rig. Additional sensor data sets from additional dates may be assigned a different accession identifier or the sensor data sets may be assigned the same identifier. In other embodiments, sensor data sets from industrial systems owned by the same entity may be assigned the same accession identifier. In yet other embodiments, data from the same industrial system may be assigned two different accession identifiers if, for example, two different operators rent the same industrial system. Different accession identifiers may also be used at different times during the data collection or for sets of data received at different times.

Different accession identifiers may be used for various other reasons. In some examples, accession identifiers may be used to label bad or suspect sets of sensor data. Accession identifiers may also be used to label data for other tracking purposes such as data auditing, for example. It should also be noted that accession identifiers can be attached before, during, or after any data preprocessing/cleaning.

In some embodiments, the accession identifiers remain associated with their corresponding sensor data sets as the sensor data sets are processed with other sensor data sets to yield models and ensemble models. As such, the contribution of each sensor data set may be readily identified in the models and ensemble models.

In some embodiments, the accession identifiers are chosen to be unique. In some embodiments, the accession identifier may be a concatenation of two or more unique identifiers. For example, a unique identifier may be first assigned to each industrial system using a lock-based method. A central server for assigning identifiers may be used with locks on assignment until a unique identifier is generated. Another partial unique identifier that may be used is the UTC time at which a sensor data set is received (which is inherently unique). The accession identifier may be then formed, for example, by concatenating the unique industrial system identifier and the unique UTC time of when a set of sensor data was received. The resulting accession identifier is unique as it was created by two other unique identifiers.

In some embodiments, the accession identifiers may be inserted as part of the file name and/or folder name of the file(s) and/or folder(s) containing the sets of sensor data. In other embodiments, the accession identifiers may be inserted as metadata of the files/folders containing the sets of sensor data. In yet other embodiments, the accession identifiers may be inserted into the header of the file(s) containing the sets of sensor data.

In embodiments where the set of sensor data is processed further and/or mixed together with other sets of data, the metadata in the header may be applied to rows in the data file that correspond to the set of sensor data. As such, specific sets of sensor data may be easily identified, if needed, in the data files.

In some embodiments, the sensor data may be tagged with accession identifiers for auditing and tracking purposes. For example, if at a later time, a set of data is determined to be erroneous, the data may be identified and removed using the accession identifiers. Generally, sensor data sets may be tagged with an accession identifier that includes a time stamp of when the data was received and/or when the data was generated. And generally, that time stamp, through the accession identifiers, may be used to identify and remove models and other data that are later discovered to be erroneous.

In some embodiments, the accession identifiers may be used as part of a billing platform. For example, in embodiments where models of various monetary values are formed from the various sets of sensor data, the accession identifiers may be used to determine the value of the different sets of data based on the value of the various models that were built from the different sets of sensor data.

At decision 450, a determination is then made as to whether additional sets of sensor data requiring accession identifiers remain. If additional sets of sensor data remain, decision 450 branches to the “yes” branch whereupon, at block 410, another set of sensor data is received and processed.

On the other hand, if no additional sets of sensor data remain, decision 450 branches to the “no” branch whereupon processing continues at block 460.

At block 460, various models may be built from the various sets of sensor data. Subsequently, ensemble models may be constructed from the various models. In some embodiments, the accession identifiers with which the sets of sensor data are tagged remain associated with each set of sensor data as the sets are processed into models and ensemble models. In some embodiments, the models and ensembles are all tagged with all of the accession numbers from all of the sets of sensor data that were used to construct each of the models and/or ensemble models. As such, contributions to the models and ensemble models by specific sets of sensor data may be identified and removed using the accession identifiers as needed.

In some embodiments, predictive models may be generated using one or more techniques such as Soft Margin Support Vector Machines, Random Forests, Boosting, Logistic Regression. Then, each individual model is labeled with the accession identifier of all sets of sensor data used to create it.

Processing subsequently ends at 499

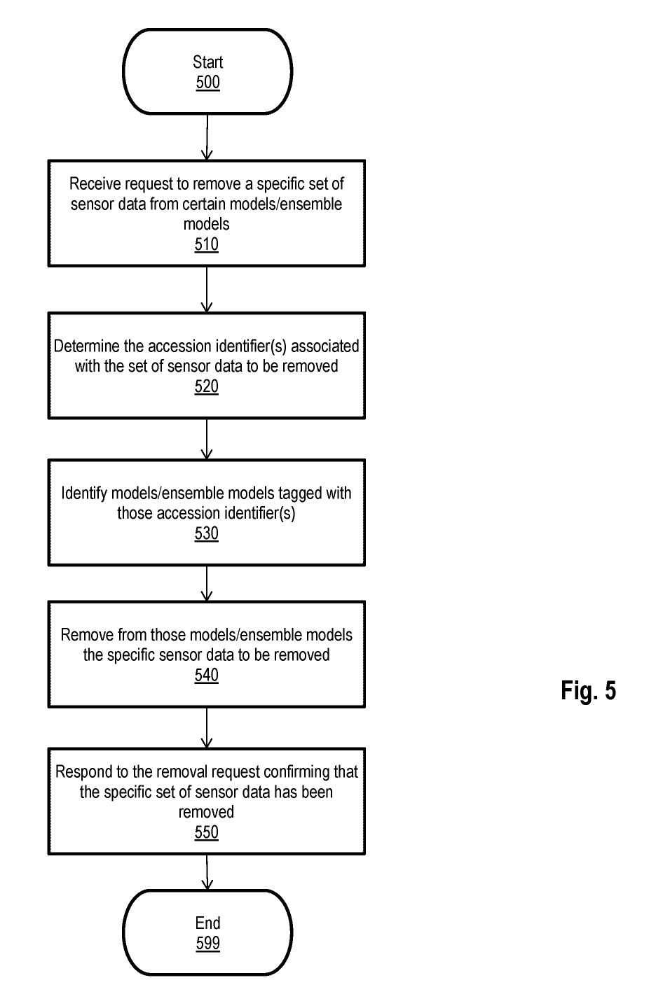

FIG. 5 is a flow diagram illustrating another method for utilizing accession identifiers to label sets of sensor data, in accordance with some embodiments.

Processing begins at 500 whereupon, at block 510, a request is received to remove a specific set of sensor data from certain models/ensemble models. In some embodiments, the request may be sent by the owner of an industrial system to which the set of sensor data belongs. In some embodiments, the removal request may be for the complete removal of the set of sensor data from all of the models/ensemble models in which the set is being used. In other embodiments, the removal request may be for the removal of the set of sensor data from specific models/ensemble models. For example, the removal request may be for removing the set from models/ensemble models being used by specific industrial systems. In yet other embodiments, the industrial system owner may also specify a specific starting and ending time for when the set of data is to be removed.

In some embodiments, reciprocity may be implemented where if a first industrial system owner requests the removal of sensor data from models being used by a second industrial system, sets of sensor data from the second industrial system in models for the first industrial system are also removed.

At block 520, the accession identifiers associated with the set of sensor data to be removed are identified. In some embodiments, one or more accession identifiers may have been assigned and associated with the set of sensor data to be removed.

In some embodiments, a record of accession identifiers and associated sensor data may be kept—a look-up table, for example, and that record may be used to determine which accession identifiers are associated with the set of data that was requested for removal.

At block 530, the models/ensemble models that are tagged with the determined accession identifiers from block 520 are identified. In some embodiments, the models and ensemble models are tagged with the accession identifiers of all of sets of sensor data that are used to construct that model or ensemble model.

At block 540, once the models and ensemble models tagged with those accession identifiers have been identified, the contribution to those models and ensemble models from those accession identifiers is removed.

Generally, the set of sensor data is removed from all processes used to construct the identified models. In embodiments where the models and/or the ensemble models are hosted on remote servers, the models and/or ensemble models may be updated remotely instead of having to be reconstructed and reuploaded to the remote servers. With the use of accession identifiers, the removal task may be significantly expedited.

In some embodiments, the use of the accession identifiers in tracking and removing data may also preserve anonymity for the source of the data as the correspondence of accession identifiers to sets of sensor data may be kept confidential.

It should be noted that, in some embodiments, accession identifiers may also be used to remove data—but also generally to track data—for other purposes. For example, data may be removed if the data is determined to be flawed in some form.

In embodiments where the simple weightings are used for each contributing set of data, removing data contribution may involve setting the weightings corresponding to the set of sensor data to be removed to zero.

In some embodiments, the use of accession identifiers in selectively removing sets of sensor data may significantly reduce the required computational power. The alternative to identifying and removing the data would have been to rebuild the models and/or ensemble models from the beginning. Computationally that may be of order n̂2, depending on how the model may be constructed. However, by identifying the appropriate set of sensor data in the appropriate model, the ensemble model may be simply rebalanced with the remaining models. Computationally this may of order n.

In terms of network bandwidth, without accession identifiers, after removing the set of sensor data and reconstructing the appropriate model, the new model would need to be retransmitted to the remote server. With the accession identifiers identifying the appropriate model and set of sensor data to be removed, the model may be rebalanced at the remote server without the need to transmit very much information over the network.

Generally, the use of accession identifiers may significantly decrease the time that it takes to remove the appropriate set of sensor data.

At block 550, a response is transmitted is sent back to the industrial system that had requested the data removal to confirm that the set of sensor data has been removed from all relevant models and/or ensemble models.

Processing subsequently ends at 599.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

One or more embodiments of the invention are described above. It should be noted that these and any other embodiments are exemplary and are intended to be illustrative of the invention rather than limiting. While the invention is widely applicable to various types of systems, a skilled person will recognize that it is impossible to include all of the possible embodiments and contexts of the invention in this disclosure. Upon reading this disclosure, many alternative embodiments of the present invention will be apparent to persons of ordinary skill in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A computer-implemented method comprising:
receiving a request to remove a contribution of a targeted sensor data set from a construction of a model, wherein:
the targeted sensor data set is from a plurality of sensor data sets,
each of the plurality of sensor data sets is associated with sensors monitoring industrial systems;
the model is constructed at least in part from the plurality of sensor data sets, and
each of the plurality of sensor data sets is tagged with at least one unique accession identifier;
identifying an accession identifier associated with the targeted sensor data set; and
modifying the construction of the model to remove the contribution of the targeted sensor data set based at least in part on identifying the accession identifier associated with the targeted sensor data set.

2. The method of claim 1, wherein modifying the model comprises setting a model weight associated with the accession identifier to zero and rebalancing the model weights associated with remaining sensor data sets from the plurality of the sensor data sets.

3. The method of claim 1, wherein the model is an ensemble model.

4. The method of claim 1, wherein the model is located on a remote server, and wherein modifying the construction of the model further comprises transmitting appropriate instructions to the remote server.

5. The method of claim 1, further comprising maintaining a look-up table containing a list accession identifiers and corresponding sets of sensor data.

6. The method of claim 1, wherein the at least one unique accession identifier comprises a temporal component associated with the date-time of when the plurality of sensor data sets was created, the method further comprising temporally identifying the targeted sensor data set based at least upon the at least one unique accession identifier.

7. The method of claim 1, wherein each of the plurality of sensor data sets being tagged with the at least one unique accession identifier comprises at least one of:
inserting the at least one unique accession identifier as part of a file name,
inserting the at least one unique accession identifier as metadata,
inserting the at least one unique accession identifier into file headers, and
inserting the at least one unique accession identifier in a separate data column.

8. A system comprising:
one or more processing units; and
one or more memory units coupled to the one or more processing units, wherein:
the one or more memory units are configured to store instructions,
the one or more processing units are configured to execute the instructions causing the system to perform operations comprising:
receiving a request to remove a contribution of a targeted sensor data set from a construction of a model, wherein:
the targeted sensor data set is from a plurality of sensor data sets,
each of the plurality of sensor data sets is associated with sensors monitoring industrial systems;
the model is constructed at least in part from the plurality of sensor data sets, and
each of the plurality of sensor data sets is tagged with at least one unique accession identifier;
identifying an accession identifier associated with the targeted sensor data set; and
modifying the construction of the model to remove the contribution of the targeted sensor data set based at least in part on identifying the accession identifier associated with the targeted sensor data set.

9. The system of claim 8, wherein modifying the model comprises setting a model weight associated with the accession identifier to zero and rebalancing the model weights associated with remaining sensor data sets from the plurality of the sensor data sets.

10. The system of claim 8, wherein the model is an ensemble model.

11. The system of claim 8, wherein the at least one unique accession identifier comprises a temporal component associated with the date-time of when the plurality of sensor data sets was created, the operations further comprising temporally identifying the targeted sensor data set based at least upon the at least one unique accession identifier.

12. The system of claim 8, wherein the model is located on a remote server, and wherein modifying the construction of the model further comprises transmitting appropriate instructions to the remote server.

13. The system of claim 8, further comprising maintaining a look-up table containing a list accession identifiers and corresponding sets of sensor data.

14. The system of claim 8, wherein each of the plurality of sensor data sets being tagged with the at least one unique accession identifier comprises at least one of:
inserting the at least one unique accession identifier as part of a file name,
inserting the at least one unique accession identifier as metadata,
inserting the at least one unique accession identifier into file headers, and
inserting the at least one unique accession identifier in a separate data column.

15. At least one non-transitory, machine-accessible storage medium having instructions stored thereon, wherein the instructions are configured, when executed on a machine, to cause the machine to perform operations comprising:
receiving a request to remove a contribution of a targeted sensor data set from a construction of a model, wherein:
the targeted sensor data set is from a plurality of sensor data sets,
each of the plurality of sensor data sets is associated with sensors monitoring industrial systems;
the model is constructed at least in part from the plurality of sensor data sets, and
each of the plurality of sensor data sets is tagged with at least one unique accession identifier;
identifying an accession identifier associated with the targeted sensor data set; and
modifying the construction of the model to remove the contribution of the targeted sensor data set based at least in part on identifying the accession identifier associated with the targeted sensor data set.

16. The storage medium of claim 15, wherein modifying the model comprises setting a model weight associated with the accession identifier to zero and rebalancing the model weights associated with remaining sensor data sets from the plurality of the sensor data sets.

17. The storage medium of claim 15, wherein the model is an ensemble model.

18. The storage medium of claim 15, wherein the model is located on a remote server, and wherein modifying the construction of the model further comprises transmitting appropriate instructions to the remote server.

19. The storage medium of claim 15, further comprising maintaining a look-up table containing a list accession identifiers and corresponding sets of sensor data.

20. The storage medium of claim 15, wherein each of the plurality of sensor data sets being tagged with the at least one unique accession identifier comprises at least one of:
inserting the at least one unique accession identifier as part of a file name,
inserting the at least one unique accession identifier as metadata,
inserting the at least one unique accession identifier into file headers, and
inserting the at least one unique accession identifier in a separate data column.
